(19) United States
(12) Patent Application Publication
(10) Pub. No.: US 2026/0292737 A1
(43) Pub. Date: Sep. 24, 2026

(54) FIXED TRANSMISSION TIMING

(71) Applicant: Nokia Technologies Oy, Espoo (FI)

(72) Inventors: Hyun-Su Cha; Ryan Keating; Tao Tao, Shanghai (CN)

(73) Assignee: Nokia Technologies Oy, Espoo (FI)

(21) Appl. No.: 19/472,976

(22) PCT Filed: Apr. 7, 2023
(86) PCT No.: PCT/CN2023/087159

§ 371 Date: Oct. 6, 2025

(51) Int. Cl. H04W 56/00; H04L 5/00

(52) U.S. Cl. CPC H04W 56/0045; H04L 5/0051

(57) ABSTRACT

Example embodiments of the present disclosure relate to constant transmission. In an example method, a terminal device transmits a reference signal (RS) for positioning at a fixed transmission timing, wherein a RS for positioning configuration is valid in multiple cells. Based on determining that at least one condition for maintaining the fixed transmission timing is not satisfied, the terminal device performs at least one operation to cause the transmission timing of a subsequent RS for positioning to be fixed with or without an update of the transmission timing. In this way, positioning measurement accuracy can be improved, and the signaling overhead between the terminal devices and the network devices, and between network devices can be reduced.

### FIELD

Example embodiments of the present disclosure generally relate to the field of telecommunication, and in particular, to devices, methods, apparatuses and a computer readable storage medium for fixing transmission timing.

### BACKGROUND

With the development of communication technology, the expended and improved New Radio (NR) has included support of Low Power High Accuracy Positioning (LPHAP). The LPHAP can provide high positioning accuracy while enable user equipment (UE)'s battery operation for mobility and long-term use.

As defined in TS 22.104, enhancements for enabling LPHAP use-case can include extending eDRX (Discontinuous Reception) cycle beyond 10.24s in RRC_INACTIVE state to meet the battery life requirement for LPHAP. Positioning-specific enhancement for eDRX cycle beyond 10.24s is defined as part of Rel-18 Work Item (WI) on expanded and improved NR positioning. Working on this objective is coordinated with that in Rel-18 WI on eRedCap (Reduced Capability). Towards this, the feature of extending eDRX cycle beyond 10.24s is defined as part of Rel-18 WI on eRedCap. Besides, inputs from RAN1 as necessary may be facilitated via LSs. However, there is a need for UEs in RRC_INACTIVE state using uplink and downlink positioning to specify SRS (Sounding Reference Signal) configuration based on SRS positioning validity area to avoid frequent RRC connection for SRS (re)configuration.

### SUMMARY

In general, example embodiments of the present disclosure provide a solution for fixing transmission timing.

In a first aspect, there is provided a terminal device. The terminal device comprises at least one processor and at least one memory storing instructions that, when executed by the at least one processor, cause the terminal device at least to: transmit a reference signal (RS) for positioning at a fixed transmission timing, wherein a RS for positioning configuration is valid in multiple cells; and based on determining that at least one condition for maintaining the fixed transmission timing is not satisfied, perform at least one operation to cause the transmission timing of a subsequent RS for positioning to be fixed with or without an update of the transmission timing.

In a second aspect, there is provided a network device. The network device comprises at least one processor and at least one memory storing instructions that, when executed by the at least one processor, cause the network device at least to: transmit, to a terminal device, a reference signal (RS) for positioning configuration valid in multiple cells; transmit, to the terminal device, configuration information for a fixed transmission timing; and receive, from the terminal device, a RS for positioning at the fixed transmission timing.

In a third aspect, there is provided a method. The method comprises transmitting, at a terminal device, a reference signal (RS) for positioning at a fixed transmission timing, wherein a RS for positioning configuration is valid in multiple cells; and based on determining that at least one condition for maintaining the fixed transmission timing is not satisfied, performing at least one operation to cause the transmission timing of a subsequent RS for positioning to be fixed. An example of the condition is that a time difference between DL reception timing and the fixed transmission timing is within a threshold value. Another example of condition is that the fixed transmission timing is the fixed transmission timing is earlier than the DL reception timing.

In a fourth aspect, there is provided a method. The method comprises transmitting, at a network device to a terminal device, a reference signal (RS) for positioning configuration valid in multiple cells; transmitting, to the terminal device, configuration information for a fixed transmission timing; and receiving, from the terminal device, a RS for positioning at the fixed transmission timing.

In a fifth aspect, there is provided an apparatus. The apparatus comprises means for transmitting, at a terminal device, a reference signal (RS) for positioning at a fixed transmission timing, wherein a RS for positioning configuration is valid in multiple cells; and means for based on determining that at least one condition for maintaining the fixed transmission timing is not satisfied, performing at least one operation to cause the transmission timing of a subsequent RS for positioning to be fixed. An example of the condition is that a time difference between DL reception timing and the fixed transmission timing is within a threshold value. Another example of condition is that the fixed transmission timing is the fixed transmission timing is earlier than the DL reception timing.

In a sixth aspect, there is provided an apparatus. The apparatus comprises means for transmitting, at a network device to a terminal device, a reference signal (RS) for positioning configuration valid in multiple cells; means for transmitting, to the terminal device, configuration information for a fixed transmission timing; and means for receiving, from the terminal device, a RS for positioning at the fixed transmission timing.

In a seventh aspect, there is provided a non-transitory computer readable medium comprising program instructions for causing an apparatus to perform at least the method according to any one of the above third to fourth aspect.

In an eighth aspect, there is provided a computer program comprising instructions, which, when executed by an apparatus, cause the apparatus at least to perform at least the method according to any one of the above third to fourth aspect.

In a ninth aspect, there is provided a terminal device. The terminal device comprises transmitting circuitry configured to transmit a reference signal (RS) for positioning at a fixed transmission timing, wherein a RS for positioning configuration is valid in multiple cells; and performing circuitry configured to base determining that at least one condition for maintaining the fixed transmission timing is not satisfied, performing at least one operation to cause the transmission timing of a subsequent RS for positioning to be fixed. An example of the condition is that a time difference between DL reception timing and the fixed transmission timing is within a threshold value. Another example of condition is that the fixed transmission timing is the fixed transmission timing is earlier than the DL reception timing.

In a tenth aspect, there is provided a network device. The network device comprises transmitting circuitry configured to transmit, to a terminal device, a reference signal (RS) for positioning configuration valid in multiple cells; transmitting circuitry configured to transmit, to the terminal device, configuration information for a fixed transmission timing; and receiving circuitry configured to receive, from the terminal device, a RS for positioning at the fixed transmission timing.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1 illustrates an example of a network environment in which some example embodiments of the present disclosure may be implemented;

FIG. 2A illustrates a process flow of method according to some embodiments of the present disclosure;

FIG. 2B illustrates an example of the fixed SRS transmission timing with DL reception timing change in accordance with some example embodiments of the present disclosure

FIG. 3 illustrates a detailed example of a process flow in accordance with some example embodiments of the present disclosure;

FIG. 4 illustrates another detailed example of a process flow in accordance with some example embodiments of the present disclosure;

FIG. 5 illustrates another detailed example of a process flow in accordance with some example embodiments of the present disclosure;

FIG. 6 illustrates a flowchart of a method implemented at a terminal device in accordance with some example embodiments of the present disclosure;

FIG. 7 illustrates a flowchart of a method implemented at a network device in accordance with some example embodiments of the present disclosure;

FIG. 8 illustrates a simplified block diagram of a device that is suitable for implementing some example embodiments of the present disclosure; and

FIG. 9 illustrates a block diagram of an example of a computer readable medium in accordance with some example embodiments of the present disclosure.

Throughout the drawings, the same or similar reference numerals represent the same or similar elements.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (for example, remote surgery), an industrial device and applications (for example, a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

In Rel-18 NR WID (Work Item Description), Sounding Reference Signal (SRS) for positioning configurations in multiple cells [RAN2, RAN1] is defined. Details including issues such as interference, timing advance, spatial relation information, pathloss reference and common SRS parameters across multiple cells can be further discussed during normative work. Pre-configuration of one or multiple SRS for positioning configurations [RAN2, RAN3] is specified. SRS for positioning activation/request procedure(s) [RAN2, RAN1] is specified. Solutions for DL PRS measurements for a UE in RRC_IDLE state and reporting of the measurements in RRC_CONNECTED state [RAN2] are specified. Solutions for alignment between eDRX and PRS configurations [RAN2] are specified. Corresponding new core requirements, as well as identifying and specifying the impact on the existing RAN4 specification, including RRM measurements and procedures [RAN4] are specified.

In Rel-18 NR positioning Study Item (SI), RAN1 discussed how to reduce the power consumption to extend battery life time for the UEs in RRC_INACTIVE state. The LPHAP device may only need positioning service, so it can be assumed the LPHAP devices would stay in the RRC_INACTIVE state for a long time. One of the identified solutions is to support uplink (UL) or downlink (DL) and UL positioning method using SRS configurations for positioning valid in multiple cells. More specifically, the gNB provides the UE with one or more SRS configurations for positioning, and the UE uses the SRS valid in multi-cell without re-configuration or update even though the UE moves to other cells. The RRC_INACTIVE state is an example of “inactive state”, which is mentioned in this invention. The RRC_IDLE state is an example of “idle mode” in this invention.

In RAN1 #112 meeting, RAN1 made the following agreements for LPHAP. For SRS for positioning configuration in multiple cells for UEs in RRC_INACTIVE state, an SRS positioning validity area consists of cells configured in the same band and the same carrier, and the following parameters with respect to BWP information of SRS for positioning configuration are commonly applied across cells within the validity area: locationAndBandwidth, subcarrierSpacing, and cyclicPrefix, where they are RRC configuration parameters defined in 3GPP TS 38.331.

For SRS for positioning configuration in multiple cells for a UE in RRC_INACTIVE state, at least the following parameters in SRS for positioning configuration are commonly configured across cells within the validity area: srs-PosConfig, SRS-PosResourceSet, srs-PosResourceSetId, srs-PosResourceIdList, resourceType, SRS-PosResource, srs-PosResourceId, transmissionComb, resourceMapping, freqDomainShift, freqHopping, groupOrSequenceHopping-r16, resourceType, FFS (whether sequenceId is configured commonly across cells or per cell), where they are RRC configuration parameters defined in 3GPP TS 38.331.

From RAN1 perspective, it is feasible to configure SRS positioning validity area-specific Timing Advance (TA) timer (e.g., with larger values) for a UE in RRC_INACTIVE state. Details can be up to RAN2. For TA validation, use of area-specific RSRP change threshold is feasible (which RS is the reference RS for the RSRP change threshold).

Rel-18 LPHAP SI identified the required features to extend the UE battery life time as the target requirement is >=6 months. This SI considered that the network may try to keep the LPHAP device in the RRC_INACTIVE state to save power. RAN1 identified that UL-based positioning is beneficial than DL-based positioning in terms of power consumption, and we should minimize the wireless data transmission reception (e.g., PDSCH (Physical Downlink Shared Channel) and PUSCH (Physical Uplink Shared Channel)). This motivated that the NR positioning enhancement WI supports a new type of SRS configuration, which is valid in multiple cells without re-configuration or update by the network.

The power consumption gain is shown in Rel-18 NR positioning SI for RRC_INACTIVE UEs by allowing the UE to keep the positioning SRS configuration valid in multiple cells. It enables the UE to avoid re-configuration of SRS when the UE connects or moves to other cells. However, it comes with transmission timing issues. The UE needs to use a proper TA (Timing Advance) value depending on its connected cell and/or location, and the used TA information needs to be transferred to neighbor cells as it needs the UE transmission timing information to measure UL positioning measurement. However, the TA reconfiguration or update by the network makes the UE consume more power as signaling exchange between the UE and the network is unavoidable. Especially for the RRC_INACTIVE UEs, the reconfiguration and transferring the TA information to neighbor cells in time would not be easy. Furthermore, multiple companies are trying to introduce positioning functionality for RRC_IDLE UEs including SRS transmission. The signaling to the RRC_IDLE UEs would be highly limited but the RRC_IDLE UEs should use a proper TA and the neighbor cells still need UL SRS transmission timing information to perform UL timing measurements.

The LPHAP device targets the low power consumption and high positioning accuracy. In Rel-18, NR positioning SI for LPHAP identified that it is beneficial for LPHAP device to reduce RACH (Random Access Channel) procedure, PDCCH (Physical Downlink Control Channel) monitoring, PDSCH reception, and PUSCH transmission. However, using TA properly is essential to operate UL-based positioning, so the reconfiguration or update may be unavoidable.

In view of the above, example embodiments of the present disclosure provide a solution for fixing transmission timing. Especially, the example embodiments of the present disclosure can improve the UL positioning measurement accuracy and reduce signaling overhead between the terminal devices and the network devices, and between network devices.

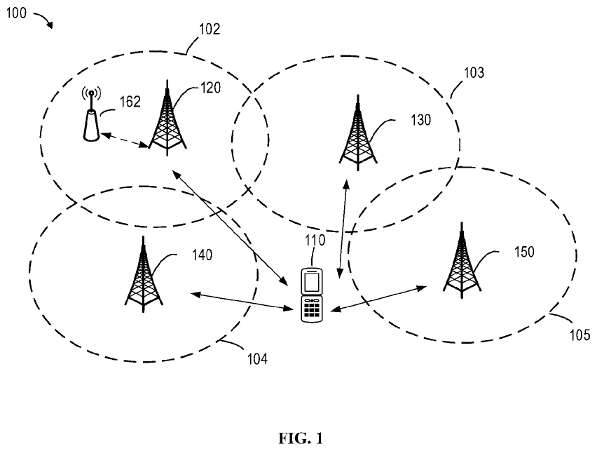

FIG. 1 illustrates an example of a network environment 100 in which some example embodiments of the present disclosure may be implemented. In the descriptions of the example embodiments of the present disclosure, the network environment 100 may also be referred to as a communication system 100 (for example, a portion of a communication network). For illustrative purposes only, various aspects of example embodiments will be described in the context of network devices and terminal devices that communicate with one another. It should be appreciated, however, that the description herein may be applicable to other types of apparatus or other similar apparatuses that are referenced using other terminology.

As illustrated in FIG. 1, the network environment 100 may comprise a terminal device 110 may comprise a first device 110 (hereinafter may also be referred to as a UE 110 or a terminal device 110). The network environment 100 may also comprise a second device 120, a third device 130, a fourth device 140, a fifth device 150 (hereinafter may also be referred to as network devices 120, 130, 140 and 150, or gNBs 120, 130, 140 and 150, or the like). The network environment 100 may also comprise a sixth device 162 (hereinafter may also be referred to as network device 162, or Location Management Function (LMF) 162, location server 162, or the like). The terminal device 110 may be configured to be communicated with network via one or more of the network devices 120, 130, 140, 150 and 162. In the network environment, a terminal device may be served by one or more of network devices 120, 130, 140,150 and 162 at the same time. The network device 162 in the communication system 100 provide one or more services (for example, network connectivity) for one terminal device 110 that may be installed within or that may roam throughout an associated geographical area. In the network environment 100, a link from the terminal device 110 to the network device 120 is referred to as an uplink, UL or a reverse link, while a link from the network device 120 to the terminal device 110 is referred to as a downlink, DL or a forward link.

It is to be understood that the number of network devices, terminal devices, or TRPs is only for the purpose of illustration without suggesting any limitations. The system 100 may include any suitable number of network devices, terminal devices, or gNBs adapted for implementing embodiments of the present disclosure. Although not shown, it would be appreciated that one or more terminal devices may be located in environment 100.

The configured SRS is valid in the last serving cell as well as the non-serving cells 102-105 (neighboring cells), and the terminal device 110 may not expect the new configuration of SRS although the connected cell/gNB is changed. However, not all parameters can be valid across multiple cells 102-105 such as the DL path-loss reference RS, the spatial relation information to determine the transmission beam of each SRS resource, timing advance, and so forth.

Communications in the network environment 100 may be implemented according to any proper communication protocol(s), comprising, but not limited to, cellular communication protocols of the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

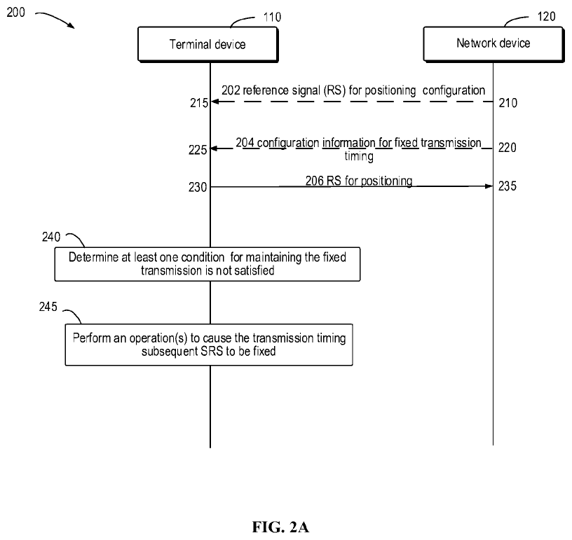

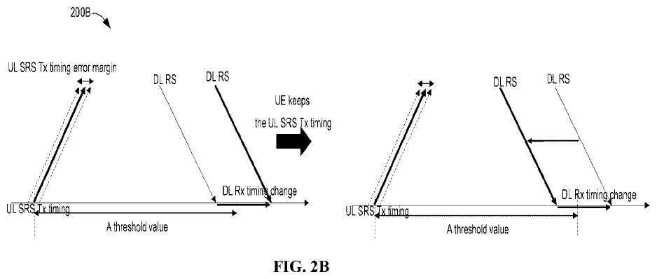

FIG. 2A illustrates a process flow of method 200 according to some embodiments of the present disclosure. For the purpose of discussion, the process flow 200 will be described with reference to FIG. 1. It would be appreciated that although the process flow 200 has been described referring to the network environment 100 of FIG. 1, this process flow 200 may be likewise applied to other similar communication scenarios.

In the process flow 200, the terminal device 110 may receive (215) a reference signal (RS) for positioning configuration 202 which is valid in multiple cells (such as cells 102-105) and receive (225) configuration information for a fixed transmission timing 204 from the network device 120. The terminal device 110 may then transmit (230) RS for positioning 206 at the fixed transmission timing to the network device 120. In some embodiments, the terminal device 110 may be in an idle state. The RS for positioning may comprise a sidelink reference signals for positioning and/or a sounding reference signal (SRS) for positioning.

In some embodiments, the fixed transmission timing may be configured by the network device 120 together with the RS for positioning configuration or configured by the network device 120 via broadcast signaling or dedicated signaling. In some embodiments, the fixed transmission timing may be a transmission timing used by the terminal device 110 in a previous serving cell (such as cells 103-105) or the fixed transmission timing may be indicated to the terminal device 110 when a positioning session is initiated.

The terminal device 110 may then decide whether the conditions for maintaining the fixed transmission timing is satisfied. In some embodiments, the conditions for maintaining the fixed transmission timing may be a time difference between DL reception timing and the fixed transmission timing is within a threshold value. In some embodiments, the conditions for maintaining the fixed transmission timing may be the fixed transmission timing is earlier than the DL reception timing.

In some embodiments, the threshold value may be decided based on the following factors: a configurable range of a timing advance (TA) value; time synchronization difference between multiple cells; a maximum distance within a validity area for the RS for positioning configuration; a maximum allowable TA value; a number of cells in the validity area; a cyclic prefix; a maximum tolerable timing offset at a transmission reception point (TRP) to still achieve a predefined relative time of arrival (RTOA) measurement accuracy. In some embodiments, the threshold value may be configured by the network device 120; predefined; or determined based on a capability of the terminal device 110.

If the terminal device 110 determine (240) that at least one condition for maintaining the fixed transmission timing is not satisfied, the terminal device 110 may perform (245) at least one operation to cause the transmission timing of a subsequent RS for positioning to be fixed with or without an update of the transmission timing. In some embodiments, when performing the one or more operations, the terminal device 110 may transmit, to the network device 120, a request for updating reference information for the terminal device to determine DL reception timing. Upon receiving, from the network device 120, the updated reference information, the terminal device 110 may maintain the fixed transmission timing. In some embodiments, in order to maintain the fixed transmission timing, the terminal device 110 may use the DL reception timing determined by the updated reference information.

In some embodiments, the terminal device 110 may be further caused to continue to use the fixed transmission timing prior to receiving the updated reference information. In some embodiments, the terminal device 110 may be further caused to stop transmitting subsequent RS for positioning if the terminal device 110 does not receive the updated reference information until a timer expires.

In some embodiments, the fixed transmission timing may be a first fixed transmission timing, and the terminal device 110 may update the first fixed transmission timing based on configuration information provided by the network device 120 to obtain second fixed transmission timing; or the terminal device 110 may update the first fixed transmission timing based on an arbitrary value to obtain second fixed transmission timing in the absence of the configuration information. In some embodiments, the fixed transmission timing may be maintained independent of the followings: DL reception timing; configured timing advance (TA) value(s); or uplink (UL) transmission timing for data reference signals or channels (including Physical Uplink Shared Channel and Physical Uplink Control Channel) other than the RS for positioning. In some embodiments, the fixed transmission timing may be defined within a predefined error range.

In some embodiments, the configuration information comprises one or more candidate values, and the terminal device 110 may be caused to update the first fixed transmission timing by selecting a value from the one or more candidate values; and the terminal device 110 may adjust the first fixed transmission timing to the second fixed transmission timing based on the value.

In some embodiments, the one or more candidate values are associated with one or more cell IDs or associated with one or more transmission reception point (TRP) IDs, and the terminal device 110 may be caused to select the value by determining, from the one or more cell IDs or from the one or more TRP IDs, a cell ID or a TRP ID corresponding to a cell or a TRP with a highest received signal quality; and the terminal device 110 may select, among the one or more candidate values, the value which is associated with the determined cell ID or TRP ID. The received signal quality may comprise Reference Signal Received Power (Reference Signal Received Power), RSRPP (Reference Signal Received Power per Path) of the first arrival path, and Signal-to-noise ratio (SNR). The terminal device 110 may then report second fixed transmission timing and/or the selected value to the network device 120. In some embodiments, the terminal device 110 may transmit the subsequent RS for positioning at the second fixed transmission timing.

In some embodiments, the terminal device 110 may select a candidate reference from multiple candidate references configured by a network device 120 for the terminal device to determine DL reception timing; and maintaining the fixed transmission timing by using DL reception timing determined based on the selected candidate reference. Among the multiple candidate references, the selected candidate reference may be associated with a maximum reference signal received power (RSRP), a maximum reference signal received power per path (RSRPP) of a first arrival path, or a shortest propagation time. The information of a candidate reference among the multiple candidate references may be a DL RS index; a cell index and a DL RS transmitted from a cell with the cell index; or a cell ID, a TRP ID within the cell, a DL positioning reference signal (PRS) resource set ID transmitted from the TRP, and a DL PRS resource ID.

In some embodiments, the terminal device 110 may receive, from the network device 120, a request that the terminal device to report the selected candidate reference to the network device. The terminal device 110 may then report the selected candidate reference to the network device 120.

On the other side, the network device 120 may transmit (210) a reference signal (RS) for positioning configuration which is valid in multiple cells to the terminal device 110. The network device 120 may also transmit (220) configuration information for a fixed transmission timing 204 to the terminal device 110. The network device 120 may then receive (235), a RS for positioning at the fixed transmission timing from the terminal device 110. In some embodiments, the configuration information is indicative of the fixed transmission timing. In some embodiments, configuration information is indicative of conditions for maintaining the fixed transmission timing, and the conditions may comprise a time difference between the DL reception timing and the fixed transmission timing is within a threshold value, or the fixed transmission timing is earlier than the DL reception timing. In some embodiments, the fixed transmission timing is defined within a predefined error range. In some embodiments, the terminal device 110 is in an inactive state or an idle state.

In some embodiments, the network device 120 may be further caused to determine the threshold value based on the following factors: a configurable range of a timing advance (TA) value; time synchronization difference between multiple cells; a maximum distance within a validity area for the RS for positioning configuration; a maximum allowable TA value; a number of cells in the validity area; a cyclic prefix; a maximum tolerable timing offset at a transmission reception point (TRP) to still achieve a predefined relative time of arrival (RTOA) measurement accuracy.

In some embodiments, the network device 120 may receive a request for updating reference information for the terminal device to determine DL reception timing from the terminal device 110, and the network device 120 may transmit the updated reference information to the terminal device 110.

In some embodiments, the fixed transmission timing is first fixed transmission timing, and the configuration information is further used for updating the first fixed transmission timing to second fixed transmission timing. In some embodiments, the configuration information comprises one or more candidate values for updating the first fixed transmission timing to second fixed transmission timing. In some embodiments, the configuration information may further comprise multiple candidate references for the terminal device to determine DL reception timing. In some embodiments, the multiple candidate references comprise a DL RS index; a cell index and a DL RS transmitted from a cell with the cell index; or a cell ID, a TRP ID within the cell, a DL positioning reference signal (PRS) resource set ID transmitted from the TRP, and a DL PRS resource ID.

In some embodiments, the network device 120 may receive a report of the second fixed transmission timing or a selected value from the one or more candidate values from the terminal device 110, and the network device 120 may transmit the second fixed transmission timing to at least one neighbor network device 130 or a core network device 140. In some embodiments, the network device 120 may transmit a request that the terminal device to report the selected candidate reference to the terminal device 110, and the network device 120 may receive a report of the selected candidate reference from the terminal device 110.

In some embodiments, the fixed transmission timing is maintained independent of following factors: DL reception timing, configured timing advanced (TA) value(s), or uplink (UL) transmission timing for reference signals or channels other than the RS for positioning.

FIG. 2B illustrates an example of the fixed SRS transmission timing with DL reception timing change in accordance with some example embodiments of the present disclosure. It might not be feasible for the UE to keep an exactly same transmission timing due to hardware impairments, so there may be an error margin and may be defined as a requirement. It is applied to methods 300-500 described below.

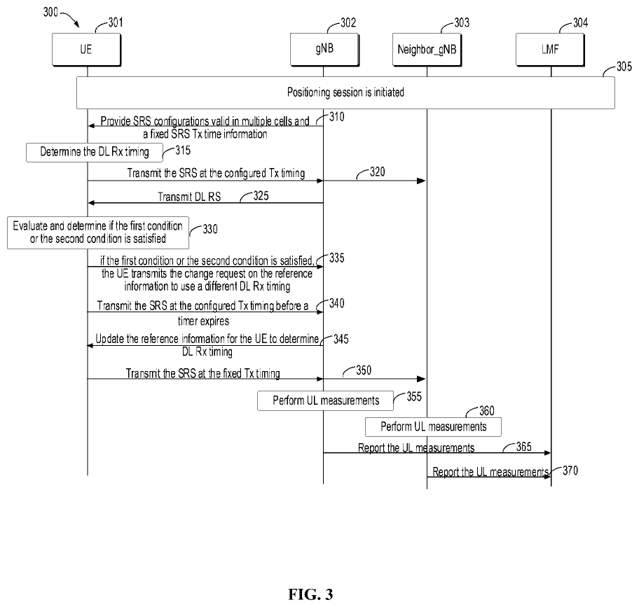

FIG. 3 illustrates a detailed example of a process flow 300 in accordance with some example embodiments of the present disclosure. It is noted that the process flow 300 can be deemed as a further example of the process flow 200. For example, the UE 301 may be one of the example devices of the terminal device 110, the gNBs 302-303 may be the example devices of the network device 120, and Location Management Function (LMF) 304 may be the one of example devices of the network device 162. It is to be understood that these devices are described only for the purpose of illustration without suggesting any limitation as to the scope of the disclosure. This process will be described in detail as follows.

In general, a UE 301 is configured with one or multiple SRS configuration(s) for positioning valid in two or more cells. This SRS configuration may be for RRC_INACTIVE or RRC_IDLE UEs, and an SRS configuration may include multiple SRS resource sets and multiple SRS resources in each SRS resource set. The UE 301 is configured to use a fixed transmission timing to transmit the configured SRS for positioning. Thus, the UE 301 may maintain the transmission timing independent with downlink (DL) reception timing and/or UL transmission timing for other data/channels. In some embodiments, the configured BWP may be independent with UL SRS transmission. For example, the SRS configuration may not be tied to an active or initial BWP depending on use cases. The UE (RRC_INACTIVE or RRC_IDLE) is not expected to enforce to maintain the fixed UL transmission timing when it operates in the active/initial UL BWP (Bandwidth Part) for data communication.

In some embodiments, the fixed transmission timing may be configured by network together with SRS configuration. That is, the required configuration information for the fixed transmission timing may be included in the SRS configuration. In some embodiment, the fixed transmission timing may be the transmission timing used by the UE 301 in last serving cell. In another embodiment, the fixed transmission timing may be indicated when the positioning session is initiated.

At 305, when the positioning session is initiated, UE 301 may request the gNB 302 to provide 310 configuration information of a different reference such as a DL RS, a cell index with DL RS index to update DL reception timing. In this method, the UE 301 depends on the update or reconfiguration from the gNB 302. At 315, the UE 301 may determine DL reception timing. At 320, the UE 301 may transmit SRS at the configured transmission timing to the gNB 302 and neighbor gNB 303. At 325, the gNB 302 may transmit DL RS to the UE 301.

At 330, the UE 301 may evaluate and determine if the first condition or the second condition is satisfied. The first condition is in case that a time difference between the DL reception timing and the UL SRS transmission timing exceeds a threshold value, the UE 301 may report this event to the network. This threshold value is tightly related to the maximum value of configurable TA. Without consideration of the other factors, the gNB 302 determines TA value based on the propagation delay estimated from the UL RS or RACH. At the UE 302, the transmission timing is the indicated TA value prior to the DL reception timing. Thus, if the time difference of the UL Transmission timing and DL Reception timing is greater than the configurable maximum TA value, it violates the current NR system. The threshold configuration is actually up to the gNB decision, but the gNB may consider at least the maximum configurable TA value and the time synchronization between gNBs.

The second condition is in case the UE DL reception timing is changed to a timing earlier than the UE UL transmission timing, the UE 301 reports this event to the network. In some embodiments, if the UE 301 determines both the first condition and the second condition are not satisfied, the UE keep transmitting SRS at the configured transmission timing. This condition is in order to not violate the current system. The UE UL uplink frame timing is ahead of the UE DL reception timing. The UE 301 first determines DL reception timing based on an SSB (or SS/PBCH block), but the UE does not decide TA by itself. The UE 301 transmits a specific RACH preamble associated with the SSB. From this pre-defined UE behavior, the gNB can estimate the propagation time as the gNB does not have the UE location information. And then, the gNB indicates UE to determine UL transmission timing as the TA before the UE DL reception timing. This event occurs if the UE DL reception timing is located before the UE UL transmission timing as the UE fixes the UL transmission timing.

For example, the UE 301 may use the RACH procedure to report the event to the network. Based on the current NR system, the UE 301 may need to change the UL SRS Transmission timing to use the configured TA value. However, in this disclosure, the UE 301 may still use the fixed UL SRS transmission timing and it waits until the network guarantees a different UE DL reception timing.

In some embodiments, to determine the threshold value, the network may consider the current configurable range of the TA value. In the current system, the UE UL transmission timing is determined by TA based on a reference UE DL Rx timing. Thus, if a time difference between the UE DL reception timing and the UE UL SRS transmission timing exceeds the maximum configurable TA value, it violates the current system design, so this threshold value would be reasonable.

In some embodiments, the network may consider the CP (cyclic prefix) length with time synchronization difference between multi-cells in the validity region in order to avoid interference issue. The threshold value may be configured by the network (e.g., via RRC or LPP configuration) or it may be hard coded into the specification or it may be up to UE capability. If the UE 301 does not receive a response from the network until a timer expires, the UE may stop the SRS transmission.

At 335, if the UE 301 decides the first condition or the second condition is satisfied, the UE 301 may transmit the change request on the reference information to use a different DL Reception timing. At 340, the UE 301 may transmit the SRS at the configured transmission timing before a timer expires. At 345, the gNB 302 may update the reference information for the UE to determine the UE DL Reception timing where the information includes DL RSs and/or cell ID(s), so that the time difference between UE DL Rx timing and the UE UL SRS transmission timing is in the threshold value.

In the case that the threshold value is configured by the network, it may be computed based on the followings: Maximum distance within the validity area (i.e., diameter in case of circular validity area), maximum allowable TA value, number of cells in the validity area, cyclic prefix, maximum tolerable timing offset at TRP to still achieve accurate RTOA measurements.

At 350, the UE 301 may transmit the SRS at the fixed transmission timing to gNB 302 and neighbor gNB 303. At 355, upon receiving the SRS, gNB 302 may perform UL measurements. At 360, upon receiving the SRS, neighbor gNB 303 may perform UL measurements. At 365, gNB 302 may report UL measurements to LMF 304. At 370, neighbor gNB 303 may report UL measurements to LMF 304.

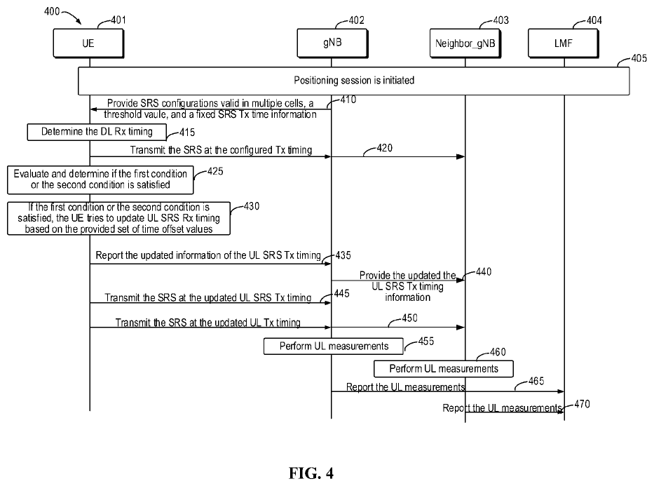

FIG. 4 illustrates another detailed example of a process flow 400 in accordance with some example embodiments of the present disclosure. It is noted that the process flow 400 can be deemed as a further example of the process flow 200. It is to be understood that these devices are described only for the purpose of illustration without suggesting any limitation as to the scope of the disclosure. This process will be described in detail as follows.

At 405, when the positioning session is initiated, the UE 401 may request the gNB 402 to provide 410 SRS configuration which is valid in multiple cells, a threshold value, and a fixed SRS transmission information. At 415, the UE 401 may determine DL reception timing. At 420, the UE 401 may transmit SRS at the configured transmission timing to the gNB 402 and neighbor gNB 403.

At 425, the UE 401 may evaluate and determine if the first condition or the second condition is satisfied. The first condition is a time difference between the DL Rx timing and the UL SRS transmission timing exceeds a threshold value, and the second condition is UE DL reception timing is changed to a timing earlier than the UE UL transmission timing. At 430, if the first condition or the second condition is satisfied, the UE 401 may try to update UL SRS reception timing based on the provided set of time offset value. In some embodiments, the UE 401 may update the UL transmission timing based on a configuration from network.

The UE 401 may be configured with one or multiple candidate values for UL SRS transmission timing change. For example, the network provides UE with {δ₁, δ₂, . . . , δ_{N}} which can be included in SRS configuration or a system information block (SIB), where N>=1. This value is delta value representing time offset, and the UE 401 may add/subtract it to/from the current SRS transmission timing.

If the time difference between the UE DL Rx timing and the UE UL SRS transmission timing exceeds the threshold, the UE 401 selects one of the values {δ₁, δ₂, . . . , δ_{N}} and change the UL SRS transmission timing based on the selected value, so that the time difference between UE DL Rx timing and UE UL SRS transmission timing is within the threshold value. How the UE 401 selects the delta value may optionally be associated with another parameter. For example, each delta value is associated with a specific cell ID within the validity area. When the UE needs to apply the delta value it first looks at the cell ID of the strongest cell and then picks the associated delta value. Similarly, SSB could be associated with the delta values.

In some embodiments, the gNB 402 may also preemptively signal to the UE 401 to update the timing based on the delta values {δ₁, δ₂, . . . , δ_{N}}. For example, the LMF/gNB may be able to notice the time drifting from the UE too much.

At 435, the UE 401 may report updated information of the UL SRS transmission timing to gNB 402. In some embodiments, the UE 401 may report the selected value to the serving gNB 402. At 440, the serving gNB 402 may provide the neighbor gNBs 403 with the updated UL SRS transmission timing of the UE. In some embodiments, based on the current NRPPa (NR Positioning Protocol a) protocol, the serving gNB 402 may provide the LMF 404 with the updated UL SRS transmission timing of the UE, and the LMF 404 transfers this information to the neighboring cells. The fixed UL SRS transmission timing may be defined within a certain error range or requirement. At 445, the UE 401 may transmit the SRS at the updated UL SRS transmission timing to the gNB 402. At 450, the UE 401 may transmit the SRS at the updated UL transmission timing to the gNB 402 and neighbor gNBs 403.

At 455, upon receiving the SRS, gNB 402 may perform UL measurements. At 460, upon receiving the SRS, neighbor gNB 403 may perform UL measurements. At 465, gNB 402 may report UL measurements to LMF 404. At 470, neighbor gNB 403 may report UL measurements to LMF 404. If the network does not provide the configuration, the UE 401 may select an arbitrary value to update the transmission timing so that the UL SRS transmission timing is in the threshold. If the updated UL SRS transmission timing based on the provided set of time offset values avoids satisfying the conditions, the UE 401 may keep transmitting SRS at the configured transmission timing.

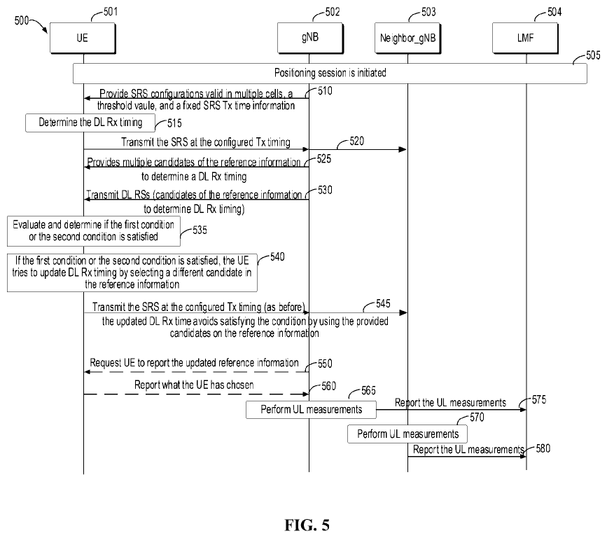

FIG. 5 illustrates another detailed example of a process flow 500 in accordance with some example embodiments of the present disclosure. It is noted that the process flow 500 can be deemed as a further example of the process flow 200. It is to be understood that these devices are described only for the purpose of illustration without suggesting any limitation as to the scope of the disclosure. This process will be described in detail as follows.

In this method, the UE 501 may minimize the re-configuration or update from the network. At 505, when the positioning session is initiated, the UE 501 may request the gNB 502 to provide 510 SRS configuration which is valid in multiple cells, a threshold value, and a fixed SRS transmission information. At 415, the UE 501 may determine DL reception timing. At 520, the UE 501 may transmit SRS at the configured transmission timing to the gNB 402 and neighbor gNB 403.

At 525, the gNB 502 may provide the UE 501 with information of multiple candidate references of the UE DL reception timing such as reference cell. At 530, the gNB 502 may also transmit DL RSs to 501, which is used at the UE 501 to determine the DL reception timing. More specifically, the information of candidate reference can be a DL RS index, a specific cell index and a DL RS transmitted from the cell. For example, a specific cell ID and DL SSB indexes can be included in the reference information to determine DL Rx timing such as (cell #1, SSB #1), (cell #2, SSB #2).

In some embodiments, the information of candidate reference can be (Cell ID, TRP ID, PRS resource set ID, PRS resource ID). More specifically, a specific cell ID, a TRP ID within the cell, and PRS resource set ID transmitted from the TRP, and PRS resource ID(s) can be configured as information of a candidate reference for the UE 501 to determine the DL Rx timing such as (cell #1, TRP #1, PRS resource set #1, PRS resource #1)

The criterion to select a candidate may comprise the UE 501 may be configured to select a candidate in the provided reference information that shows the maximum RSRP (Reference Signal Received Power), RSRPP (Reference Signal Received Power per Path) of the first arrival path, or the shortest propagation time.

At 535, the UE 501 may evaluate and determine if the first condition or the second condition is satisfied. The first condition is a time difference between the DL Rx timing and the UL SRS transmission timing exceeds a threshold value, and the second condition is UE DL reception timing is changed to a timing earlier than the UE UL transmission timing. At 540, if the first condition or the second condition is satisfied, the UE 501 may switch (or select) a candidate reference to change the DL reception timing, so that the time difference between the DL reception timing and the UL SRS transmission timing can be within the threshold value.

The UE 501 may select a candidate in reference information, but the UE 501 keep maintaining the UL SRS transmission timing. At 545, the UE 501 may transmit SRS at the configured transmission timing to gNB 502 and neighbor gNB 503 as before, and the updated DL reception timing avoids satisfying the conditions by using the provided candidates on the reference information. In other words, the UE 501 tries to keep using the fixed transmission timing by changing the DL reception timing. The UE 501 may try to use one of the multiple candidates and try to find one that can avoid satisfying the two conditions. If a selected candidate in the reference information not satisfying the two conditions, the UE 501 may use it to determine the DL reception timing. Consequently, the UE can maintain the currently fixed transmission timing. Thus, the UE 501 does not need to report transmission timing information. If the UE 501 failed to find a candidate in the reference information not satisfying the two conditions, the UE 501 may report this information to the network.

Optionally, at 550, the gNB 502 may request the UE 501 to report the updated reference information. At 560, the UE 501 may report what it has chosen to the gNB 502. The UE 501 is not mandated to report the reference after update, but the UE 501 can be indicated to report the selected reference to the gNB 502 in a measurement report. At 565, upon the gNB 502 may perform UL measurements. At 570, the neighbor gNB 503 may perform UL measurements. At 575, gNB 502 may report UL measurements to LMF 504. At 580, neighbor gNB 503 may report UL measurements to LMF 504.

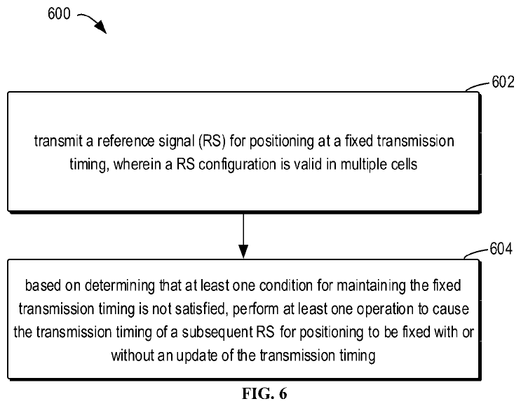

FIG. 6 illustrates a flowchart of a method 600 implemented at a terminal device in accordance with some example embodiments of the present disclosure. For the purpose of discussion, the method 600 will be described from the perspective of the terminal device 110 with reference to FIG. 1.

At block 602, the terminal device 110 may transmit a reference signal (RS) for positioning at a fixed transmission timing, wherein a RS for positioning configuration is valid in multiple cells. At block 604, the terminal device 110 may base on determining that at least one condition for maintaining the fixed transmission timing is not satisfied, perform at least one operation to cause the transmission timing of a subsequent RS for positioning to be fixed with or without an update of the transmission timing.

In some example embodiments, the fixed transmission timing may be at least one of the following: configured by a network device together with the RS for positioning configuration; configured by a network device via broadcast signaling or dedicated signaling; a transmission timing used by the terminal device in a previous serving cell; or indicated to the terminal device when a positioning session is initiated. In some example embodiments, at least one condition may comprise: a time difference between DL reception timing and the fixed transmission timing is within a threshold value; or the fixed transmission timing is earlier than the DL reception timing.

In some example embodiments, the threshold value may be determined based on at least one of the following: a configurable range of a timing advance (TA) value; time synchronization difference between multiple cells; a maximum distance within a validity area for the RS for positioning configuration; a maximum allowable TA value; a number of cells in the validity area; a cyclic prefix; a maximum tolerable timing offset at a transmission reception point (TRP) to still achieve a predefined relative time of arrival (RTOA) measurement accuracy.

In some example embodiments, the threshold value may be one of the following: configured by a network device; predefined; or determined based on a capability of the terminal device. In some example embodiments, the at least one operation comprises: transmitting, to a network device, a request for updating reference information for the terminal device to determine DL reception timing; and based on receiving, from the network device, the updated reference information, maintaining the fixed transmission timing.

In some example embodiments, based on receiving, from the network device, the updated reference information, maintaining the fixed transmission timing may further comprise: using the DL reception timing determined by the updated reference information. In some example embodiments, the terminal device may be further caused to at least one of the following: prior to receiving the updated reference information, continue use of the fixed transmission timing; and based on not receiving the updated reference information until a timer expires, stop transmitting subsequent PRS.

In some example embodiments, the fixed transmission timing is first fixed transmission timing, and wherein the at least one operation may comprise one of the following: updating the first fixed transmission timing based on configuration information provided by a network device to obtain second fixed transmission timing; or in the absence of the configuration information, updating the first fixed transmission timing based on an arbitrary value to obtain second fixed transmission timing.

In some example embodiments, the configuration information may comprise one or more candidate values, and wherein the terminal device may be caused to update the first fixed transmission timing by: selecting a value from the one or more candidate values; and adjusting, based on the value, the first fixed transmission timing to the second fixed transmission timing.

In some example embodiments, the one or more candidate values are associated with one or more cell IDs or associated with one or more transmission reception point (TRP) IDs, and wherein the terminal device may be caused to select the value by: determining, from the one or more cell IDs or from the one or more TRP IDs, a cell ID or a TRP ID corresponding to a cell or a TRP with a highest received signal quality; and selecting, among the one or more candidate values, the value which is associated with the determined cell ID or TRP ID.

In some example embodiments, the received signal quality may comprise at least one of the following: Reference Signal Received Power (Reference Signal Received Power); RSRPP(Reference Signal Received Power per Path) of the first arrival path, and Signal-to-noise ratio (SNR).

In some example embodiments, the terminal device 110 may be further caused to: report, to the network device, at least one of the second fixed transmission timing or the selected value. In some example embodiments, the terminal device 110 may be further caused to: transmit the subsequent RS for positioning at the second fixed transmission timing. In some example embodiments, the at least one operation may comprise: selecting a candidate reference from multiple candidate references configured by a network device for the terminal device to determine DL reception timing; and maintaining the fixed transmission timing by using DL reception timing determined based on the selected candidate reference.

In some example embodiments, among the multiple candidate references, the selected candidate reference may be associated with a maximum reference signal received power (RSRP), a maximum reference signal received power per path (RSRPP) of a first arrival path, or a shortest propagation time. In some example embodiments, information of a candidate reference among the multiple candidate references comprises at least one of the following: a DL RS index; a cell index and a DL RS transmitted from a cell with the cell index; or a cell ID, a TRP ID within the cell, a positioning reference signal (PRS) resource set ID transmitted from the TRP, and a PRS resource ID.

In some example embodiments, the terminal device may be further caused to: receive, from the network device, a request that the terminal device to report the selected candidate reference to the network device; and report the selected candidate reference to the network device. In some example embodiments, the fixed transmission timing may be maintained independent of at least one of the following: DL reception timing; configured timing advance (TA) value(s); or uplink (UL) transmission timing for reference signals or channels other than the RS for positioning.

In some example embodiments, the fixed transmission timing is defined within a predefined error range. In some example embodiments, at least one of the following: the terminal device is in an idle state; the device is an inactive state; the RS for positioning comprises a sidelink reference signals for positioning; or the RS for positioning comprises a sounding reference signal (SRS) for positioning.

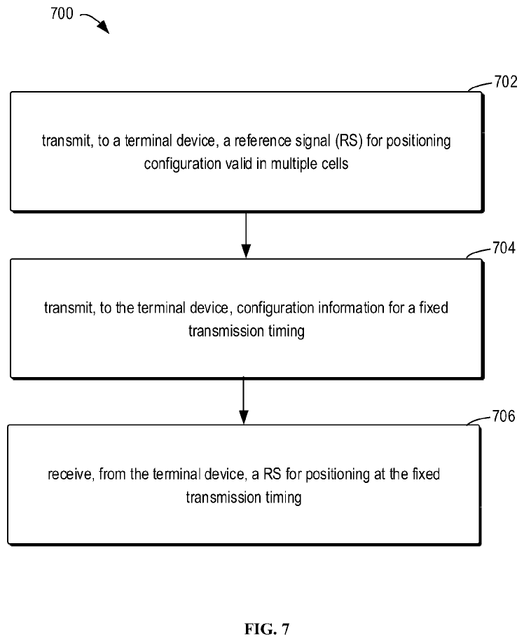

FIG. 7 illustrates a flowchart of a method 700 implemented at a network device in accordance with some example embodiments of the present disclosure. For the purpose of discussion, the method 700 will be described from the perspective of the network device 120 with reference to FIG. 1.

At block 702, the network device 120 may transmit, to a terminal device, a reference signal (RS) for positioning configuration valid in multiple cells. At block 704, the network device 120 may transmit, to the terminal device, configuration information for a fixed transmission timing. At block 706, the network device 120 may receive, from the terminal device, a RS for positioning at the fixed transmission timing.

In some example embodiments, the configuration information may be indicative of the fixed transmission timing. In some example embodiments, the configuration information may be indicative of at least one of the following conditions for maintaining the fixed transmission timing: a time difference between the DL reception timing and the fixed transmission timing is within a threshold value; or the fixed transmission timing is earlier than the DL reception timing.

In some example embodiments, the network device 120 may be further caused to determine the threshold value based on at least one of the following: a configurable range of a timing advance (TA) value; time synchronization difference between multiple cells; a maximum distance within a validity area for the RS for positioning configuration; a maximum allowable TA value; a number of cells in the validity area; a cyclic prefix; a maximum tolerable timing offset at a transmission reception point (TRP) to still achieve a predefined relative time of arrival (RTOA) measurement accuracy.

In some example embodiments, the network device 120 may be further caused to: receive, from the terminal device, a request for updating reference information for the terminal device to determine DL reception timing; and transmit the updated reference information to the terminal device. In some example embodiments, the fixed transmission timing is first fixed transmission timing, and the configuration information may be further used for updating the first fixed transmission timing to second fixed transmission timing.

In some example embodiments, the configuration information may comprise one or more candidate values for updating the first fixed transmission timing to second fixed transmission timing. In some example embodiments, the one or more candidate values may be associated with one or more cell IDs or associated with one or more transmission reception point (TRP) IDs. In some example embodiments, the network device 120 may be further caused to: receive, from the terminal device, a report of the second fixed transmission timing or a selected value from the one or more candidate values; and transmit the second fixed transmission timing to at least one neighbor network device or a core network device.

In some example embodiments, the configuration information may further comprise multiple candidate references for the terminal device to determine DL reception timing. In some example embodiments, the multiple candidate references may comprise at least one of the following: a DL RS index; a cell index and a DL RS transmitted from a cell with the cell index; or a cell ID, a TRP ID within the cell, a DL positioning reference signal (PRS) resource set ID transmitted from the TRP, and a DL PRS resource ID.

In some example embodiments, the network device may be further caused to: transmit, to the terminal device, a request that the terminal device to report the selected candidate reference; and receive, from the terminal device, a report of the selected candidate reference. In some example embodiments, the fixed transmission timing may be maintained independent of at least one of the following: DL reception timing; Configured timing advanced (TA) value(s) or uplink (UL) transmission timing for reference signals or channels other than the RS for positioning.

In some example embodiments, the fixed transmission timing may be defined within a predefined error range. In some example embodiments, at least one of the following: the terminal device is in an idle state; the RS for positioning comprises a sidelink reference signals for positioning; or the RS for positioning comprises a sounding reference signal (SRS) for positioning.

In some embodiments, an apparatus capable of performing any of the method 600 (for example, the terminal device 110) may comprise means for performing the respective steps of the method 600. The means may be implemented in any suitable form. For example, the means may be implemented in a circuitry or software module.

In some embodiments, the apparatus comprises means for transmitting a reference signal (RS) for positioning at a fixed transmission timing, wherein a RS for positioning configuration is valid in multiple cells. In some embodiments, the apparatus comprises means for based on determining that at least one condition for maintaining the fixed transmission timing is not satisfied, perform at least one operation to cause the transmission timing of a subsequent RS for positioning to be fixed with or without an update of the transmission timing.

In some example embodiments, the fixed transmission timing may be at least one of the following: configured by a network device together with the RS for positioning configuration; configured by a network device via broadcast signaling or dedicated signaling; a transmission timing used by the terminal device in a previous serving cell; or indicated to the terminal device when a positioning session is initiated. In some example embodiments, at least one condition may comprise: a time difference between DL reception timing and the fixed transmission timing is within a threshold value; or the fixed transmission timing is earlier than the DL reception timing.

In some example embodiments, the threshold value may be determined based on at least one of the following: a configurable range of a timing advance (TA) value; time synchronization difference between multiple cells; a maximum distance within a validity area for the RS for positioning configuration; a maximum allowable TA value; a number of cells in the validity area; a cyclic prefix; a maximum tolerable timing offset at a transmission reception point (TRP) to still achieve a predefined relative time of arrival (RTOA) measurement accuracy.

In some example embodiments, the threshold value may be one of the following: configured by a network device; predefined; or determined based on a capability of the terminal device. In some example embodiments, the at least one operation comprises: transmitting, to a network device, a request for updating reference information for the terminal device to determine DL reception timing; and based on receiving, from the network device, the updated reference information, maintaining the fixed transmission timing.

In some example embodiments, based on receiving, from the network device, the updated reference information, the apparatus comprises means for maintaining the fixed transmission timing may further comprise: using the DL reception timing determined by the updated reference information. In some example embodiments, the terminal device may be further caused to at least one of the following: prior to receiving the updated reference information, continue use of the fixed transmission timing; and based on not receiving the updated reference information until a timer expires, stop transmitting subsequent PRS.

In some example embodiments, the fixed transmission timing is first fixed transmission timing, and wherein the apparatus comprises means for the at least one operation may comprise one of the following: updating the first fixed transmission timing based on configuration information provided by a network device to obtain second fixed transmission timing; or in the absence of the configuration information, updating the first fixed transmission timing based on an arbitrary value to obtain second fixed transmission timing.

In some example embodiments, the configuration information may comprise one or more candidate values, and wherein the apparatus comprises means for updating the first fixed transmission timing by: selecting a value from the one or more candidate values; and adjusting, based on the value, the first fixed transmission timing to the second fixed transmission timing.

In some example embodiments, the one or more candidate values are associated with one or more cell IDs or associated with one or more transmission reception point (TRP) IDs, and wherein the apparatus comprises means for selecting the value by: determining, from the one or more cell IDs or from the one or more TRP IDs, a cell ID or a TRP ID corresponding to a cell or a TRP with a highest received signal quality; and selecting, among the one or more candidate values, the value which is associated with the determined cell ID or TRP ID.

In some example embodiments, the received signal quality may comprise at least one of the following: Reference Signal Received Power (Reference Signal Received Power); RSRPP of the first arrival path, and Signal-to-noise ratio (SNR).

In some example embodiments, the apparatus comprises means for reporting, to the network device, at least one of the second fixed transmission timing or the selected value. In some example embodiments, the apparatus comprises means for transmitting the subsequent RS for positioning at the second fixed transmission timing. In some example embodiments, the apparatus comprises means for the at least one operation may comprise: selecting a candidate reference from multiple candidate references configured by a network device for the terminal device to determine DL reception timing; and maintaining the fixed transmission timing by using DL reception timing determined based on the selected candidate reference.

In some example embodiments, among the multiple candidate references, the selected candidate reference may be associated with a maximum reference signal received power (RSRP), a maximum reference signal received power per path (RSRPP) of a first arrival path, or a shortest propagation time. In some example embodiments, information of a candidate reference among the multiple candidate references comprises at least one of the following: a DL RS index; a cell index and a DL RS transmitted from a cell with the cell index; or a cell ID, a TRP ID within the cell, a DL positioning reference signal (PRS) resource set ID transmitted from the TRP, and a DL PRS resource ID.

In some example embodiments, the apparatus comprises means for receiving, from the network device, a request that the terminal device to report the selected candidate reference to the network device; and reporting the selected candidate reference to the network device. In some example embodiments, the fixed transmission timing may be maintained independent of at least one of the following: DL reception timing; configured timing advance (TA) value(s); or uplink (UL) transmission timing for reference signals or channels other than the RS for positioning.

In some example embodiments, the fixed transmission timing is defined within a predefined error range. In some example embodiments, at least one of the following: the terminal device is in an idle state; the RS for positioning comprises a sidelink reference signals for positioning; or the RS for positioning comprises a sounding reference signal (SRS) for positioning.

In some embodiments, the apparatus further comprises means for performing other steps in some embodiments of the method 600. In some embodiments, the means comprises at least one processor and at least one memory including computer program code, the at least one memory and computer program code configured to, with the at least one processor, cause the performance of the apparatus.

In some embodiments, an apparatus capable of performing any of the method 700 (for example, the network device 120) may comprise means for performing the respective steps of the method 700. The means may be implemented in any suitable form. For example, the means may be implemented in a circuitry or software module.

In some example embodiments, the apparatus comprises means for transmitting, to a terminal device, a reference signal (RS) for positioning configuration valid in multiple cells. In some example embodiments, the apparatus comprises means for transmitting, to the terminal device, configuration information for a fixed transmission timing. In some example embodiments, the apparatus comprises means for receiving, from the terminal device, a RS for positioning at the fixed transmission timing.

In some example embodiments, the configuration information may be indicative of the fixed transmission timing. In some example embodiments, the configuration information may be indicative of at least one of the following conditions for maintaining the fixed transmission timing: a time difference between the DL reception timing and the fixed transmission timing is within a threshold value; or the fixed transmission timing is earlier than the DL reception timing.

In some example embodiments, the apparatus comprises means for determining the threshold value based on at least one of the following: a configurable range of a timing advance (TA) value; time synchronization difference between multiple cells; a maximum distance within a validity area for the RS for positioning configuration; a maximum allowable TA value; a number of cells in the validity area; a cyclic prefix; a maximum tolerable timing offset at a transmission reception point (TRP) to still achieve a predefined relative time of arrival (RTOA) measurement accuracy.

In some example embodiments, the apparatus comprises means for receiving, from the terminal device, a request for updating reference information for the terminal device to determine DL reception timing; and transmit the updated reference information to the terminal device. In some example embodiments, the fixed transmission timing is first fixed transmission timing, and the configuration information may be further used for updating the first fixed transmission timing to second fixed transmission timing.

In some example embodiments, the configuration information may comprise one or more candidate values for updating the first fixed transmission timing to second fixed transmission timing. In some example embodiments, the one or more candidate values may be associated with one or more cell IDs or associated with one or more transmission reception point (TRP) IDs. In some example embodiments, the apparatus comprises means for receiving, from the terminal device, a report of the second fixed transmission timing or a selected value from the one or more candidate values; and transmit the second fixed transmission timing to at least one neighbor network device or a core network device.

In some example embodiments, the configuration information may further comprise multiple candidate references for the terminal device to determine DL reception timing. In some example embodiments, the multiple candidate references may comprise at least one of the following: a DL RS index; a cell index and a DL RS transmitted from a cell with the cell index; or a cell ID, a TRP ID within the cell, a positioning reference signal (PRS) resource set ID transmitted from the TRP, and a PRS resource ID.

In some example embodiments, the apparatus comprises means for transmitting, to the terminal device, a request that the terminal device to report the selected candidate reference; and receiving, from the terminal device, a report of the selected candidate reference. In some example embodiments, the fixed transmission timing may be maintained independent of at least one of the following: DL reception timing; Configured timing advanced (TA) value(s) or uplink (UL) transmission timing for reference signals or channels other than the RS for positioning.

In some example embodiments, the fixed transmission timing may be defined within a predefined error range. In some example embodiments, at least one of the following: the terminal device is in an idle state; the RS for positioning comprises a sidelink reference signals for positioning; or the RS for positioning comprises a sounding reference signal (SRS) for positioning.

In some embodiments, the apparatus further comprises means for performing other steps in some embodiments of the method 700. In some embodiments, the means comprises at least one processor and at least one memory including computer program code, the at least one memory and computer program code configured to, with the at least one processor, cause the performance of the apparatus

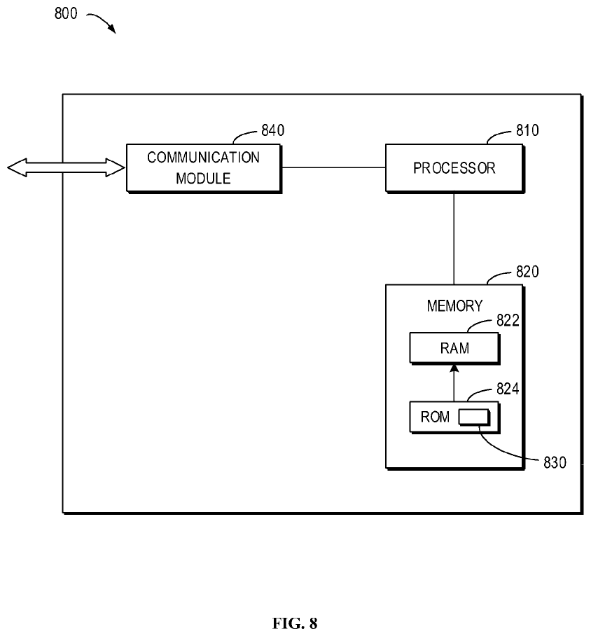

FIG. 8 illustrates a simplified block diagram of a device 800 that is suitable for implementing some example embodiments of the present disclosure. The device 800 may be provided to implement a communication device, for example, the terminal devices 110 and network devices 120-162 as shown in FIG. 1. As shown, the device 800 includes one or more processors 810, one or more memories 820 coupled to the processor 810, and one or more communication modules 840 coupled to the processor 810.

The communication module 840 is for bidirectional communications. The communication module 840 has at least one antenna to facilitate communication. The communication interface may represent any interface that is necessary for communication with other network elements.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a Read Only Memory (ROM) 824, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 822 and other volatile memories that will not last in the power-down duration.

A computer program 830 includes computer executable instructions that are executed by the associated processor 810. The program 830 may be stored in the ROM 824. The processor 810 may perform any suitable actions and processing by loading the program 830 into the RAM 822.

The embodiments of the present disclosure may be implemented by means of the program 830 so that the device 800 may perform any process of the disclosure as discussed with reference to FIGS. 2A to 7. The embodiments of the present disclosure may also be implemented by hardware or by a combination of software and hardware.

In some example embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. The computer readable medium may include any types of tangible non-volatile storage, such as ROM, EPROM, a flash memory, a hard disk, CD, DVD, and the like.

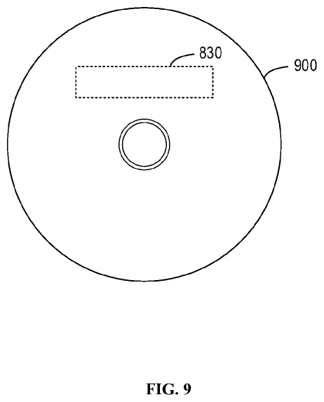

FIG. 9 illustrates a block diagram of an example of a computer readable medium 900 in accordance with some example embodiments of the present disclosure. The computer readable medium 900 has the program 830 stored thereon. It is noted that although the computer readable medium 900 is depicted in form of CD or DVD in FIG. 9, the computer readable medium 900 may be in any other form suitable for carry or hold the program 930.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 300, 400 or 500 as described above with reference to FIG. 3, 4 or 5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device comprising:
at least one processor; and
at least one memory storing instructions that, when executed by the at least one processor, cause the terminal device at least to:
transmit a reference signal (RS) for positioning at a fixed transmission timing, wherein a RS for positioning configuration is valid in multiple cells; and
based on determining that at least one condition for maintaining the fixed transmission timing is not satisfied, perform at least one operation to cause the transmission timing of a subsequent RS for positioning to be fixed with or without an update of the transmission timing.

2. The terminal device of claim 1, wherein the fixed transmission timing is at least one of the following:
configured by a network device together with the RS for positioning configuration;
configured by a network device via broadcast signaling or dedicated signaling;
a transmission timing used by the terminal device in a previous serving cell; or
indicated to the terminal device when a positioning session is initiated.

3. The terminal device of claim 1, wherein at least one condition comprises:
a time difference between DL reception timing and the fixed transmission timing is within a threshold value; or
the fixed transmission timing is earlier than the DL reception timing.

4. The terminal device of claim 3, wherein the threshold value is determined based on at least one of the following:
a configurable range of a timing advance (TA) value;
time synchronization difference between multiple cells;
a maximum distance within a validity area for the RS for positioning configuration;
a maximum allowable TA value;
a number of cells in the validity area;
a cyclic prefix;
a maximum tolerable timing offset at a transmission reception point (TRP) to still achieve a predefined relative time of arrival (RTOA) measurement accuracy.

5. The terminal device of claim 3, wherein the threshold value is one of the following:
configured by a network device;
predefined; or
determined based on a capability of the terminal device.

6. The terminal device of claim 1, wherein the at least one operation comprises:
transmitting, to a network device, a request for updating reference information for the terminal device to determine DL reception timing; and
based on receiving, from the network device, the updated reference information, maintaining the fixed transmission timing.

7. The terminal device of claim 6, wherein based on receiving, from the network device, the updated reference information, maintaining the fixed transmission timing further comprises:
using the DL reception timing determined by the updated reference information.

8. The terminal device of claim 6, wherein the terminal device is further caused to at least one of the following:
prior to receiving the updated reference information, continue use of the fixed transmission timing; and
based on not receiving the updated reference information until a timer expires, stop transmitting subsequent RS for positioning.

9. The terminal device of claim 1, wherein the fixed transmission timing is first fixed transmission timing, and wherein the at least one operation comprises one of the following:
updating the first fixed transmission timing based on configuration information provided by a network device to obtain second fixed transmission timing; or
in the absence of the configuration information, updating the first fixed transmission timing based on an arbitrary value to obtain second fixed transmission timing.

10. The terminal device of claim 9, wherein the configuration information comprises one or more candidate values, and wherein the terminal device is caused to update the first fixed transmission timing by:
selecting a value from the one or more candidate values; and
adjusting, based on the value, the first fixed transmission timing to the second fixed transmission timing.

11. The terminal device of claim 10, wherein the one or more candidate values are associated with one or more cell IDs or associated with one or more transmission reception point (TRP) IDs, and wherein the terminal device is caused to select the value by:
determining, from the one or more cell IDs or from the one or more TRP IDs, a cell ID or a TRP ID corresponding to a cell or a TRP with a highest received signal quality; and
selecting, among the one or more candidate values, the value which is associated with the determined cell ID or TRP ID.

12. The terminal device of claim 11, wherein the received signal quality comprises at least one of the following:
Reference Signal Received Power (RSRP);
Reference Signal Received Power per Path (RSRPP) of the first arrival path and Signal-to-noise ratio (SNR).

13. The terminal device of claim 9, wherein the terminal device is further caused to:
report, to the network device, at least one of the second fixed transmission timing or the selected value.

14. The terminal device of claim 9, wherein the terminal device is further caused to:
transmit the subsequent RS for positioning at the second fixed transmission timing.

15. The terminal device of claim 1, wherein the at least one operation comprises:
selecting a candidate reference from multiple candidate references configured by a network device for the terminal device to determine DL reception timing; and
maintaining the fixed transmission timing by using DL reception timing determined based on the selected candidate reference.

16. The terminal device of claim 15, wherein among the multiple candidate references, the selected candidate reference is associated with a maximum reference signal received power (RSRP), a maximum reference signal received power per path (RSRPP) of a first arrival path, or a shortest propagation time.

17. The terminal device of claim 15, wherein information of a candidate reference among the multiple candidate references comprises at least one of the following:
a DL RS index;
a cell index and a DL RS transmitted from a cell with the cell index; or
a cell ID, a TRP ID within the cell, a DL positioning reference signal (PRS) resource set ID transmitted from the TRP, and a DL PRS resource ID.

18. The terminal device of claim 15, wherein the terminal device is further caused to:
receive, from the network device, a request that the terminal device to report the selected candidate reference to the network device; and
report the selected candidate reference to the network device.

19. The terminal device of claim 1, wherein the fixed transmission timing is maintained independent of at least one of the following:
DL reception timing;
configured timing advance (TA) value(s); or
uplink (UL) transmission timing for reference signals or channels other than the RS for positioning.

20. The terminal device of claim 1, wherein the fixed transmission timing is defined within a predefined error range.

21-41. (canceled)
